(19) United States
(12) Patent Application Publication
(10) Pub. No.: US 2013/0154406 A1
(43) Pub. Date: Jun. 20, 2013

(54) SWITCHED RELUCTANCE MOTOR ASSEMBLY

(71) Applicant: Samsung Electro-Mechanics Co., Ltd., Suwon (KR)

(72) Inventor: Tae Ho Yun, Suwon (KR)

(73) Assignee: SAMSUNG ELECTRO-MECHANICS CO., LTD., Suwon (KR)

(21) Appl. No.: 13/717,600

(22) Filed: Dec. 17, 2012

(30) Foreign Application Priority Data
Dec. 19, 2011 (KR) 10-2011-0137295

(51) Int. Cl. H02K 5/16

(52) U.S. Cl. CPC H02K 5/161
USPC 310/49.43

(57) ABSTRACT

Disclosed herein is a switched reluctance motor assembly including: a shaft becoming the rotation center of the motor; a rotor part rotatably coupled to the shaft; a first bearing part coupled to an upper portion of the rotor part in an axial direction; a stopper coupled to a lower portion of the rotor part in the axial direction; and a second bearing part coupled to a lower portion of the stopper in the axial direction. According to the present invention, a distance in the axial direction between the bearing parts formed at both sides based on the shaft of the switched reluctance motor is reduced, thereby making it possible to reduce vibration and noise generated at the time of driving of the motor.

### CROSS REFERENCE TO RELATED APPLICATION

This application claims the benefit of Korean Patent Application No. 10-2011-0137295, filed on Dec. 19, 2011, entitled “Switched Reluctance Motor Assembly”, which is hereby incorporated by reference in its entirety into this application.

### BACKGROUND OF THE INVENTION

1. Technical Field

The present invention relates to a switched reluctance motor assembly.

2. Description of the Related Art

Generally, a switched reluctance motor (SRM) called an SR motor is a motor in which both of a stator and a rotor have a magnetic structure, which is a salient pole, the stator has a concentrated type coil wound therearound, and the rotor is configured only of an iron core without any type of excitation device (a winding or a permanent magnet), such that a competitive cost is excellent.

More specifically, the switched reluctance motor (SRM), which rotates a rotor using a reluctance torque according to a change in magnetic reluctance, has a low manufacturing cost, hardly requires maintenance, and has an almost permanent lifespan due to high reliability. The switched reluctance motor is configured to include: a stator part, which is a stator, including a stator yoke and a plurality of stator salient poles protruded from the stator yoke; and a rotor part, which is a rotor, including a rotor core and a plurality of rotor salient poles protruded from the rotor core so as to face the stator salient poles and rotatably received in the stator part.

This switched reluctance motor (SRM) has been used in various fields such as a vacuum cleaner, or the like. However, there is a problem that vibration or noise occurs at the time of driving of the switched reluctance motor (SRM). Particularly, as an interval between bearing parts coupled to upper and lower portions based on the switched reluctance motor (SRM) increases, the vibration and the noise due to the vibration generated at the time of the driving of the switched reluctance motor increase.

### SUMMARY OF THE INVENTION

The present invention has been made in an effort to provide a switched reluctance motor capable of reducing vibration and noise generated at the time of driving thereof by reducing an interval in an axial direction between bearing parts coupled to both sides in configuring the switched reluctance motor.

According to a preferred embodiment of the present invention, there is provided a switched reluctance motor assembly including: a shaft becoming the rotation center of the motor; a rotor part rotatably coupled to the shaft; a first bearing part coupled to an upper portion of the rotor part in an axial direction; a stopper coupled to a lower portion of the rotor part in the axial direction; and a second bearing part coupled to a lower portion of the stopper in the axial direction.

The switched reluctance motor assembly may further include: a front part formed at the upper portion of the first bearing part in the axial direction and supporting the first bearing part; a diffuser part coupled to an upper portion of the front part in the axial direction; and an impeller part coupled to an upper portion of the diffuser part in the axial direction and coupled to the shaft.

The switched reluctance motor assembly may further include: a housing enclosing an outer side of the rotor part and formed to include the first and second bearing parts; and a cover member coupled to an upper portion of the housing in the axial direction.

The switched reluctance motor assembly may further include a step part formed to be protruded along an outer peripheral surface of the housing to thereby allow the cover member to be seated thereon.

The stopper may be a balancing member.

The rotor part may include an annular rotor core and a plurality of rotor poles protruded outwardly from the rotor core.

The switched reluctance motor assembly may further include a stator part including: a stator yoke receiving the rotor part therein; and stator salient poles formed to be spaced apart from each other so as to correspond to the rotor poles and formed to be protruded inwardly of the stator yoke.

According to another preferred embodiment of the present invention, there is provided a switched reluctance motor assembly including: a shaft becoming the rotation center of the motor; a rotor part rotatably coupled to the shaft; a first bearing part coupled to an upper portion of the rotor part in an axial direction; a stopper coupled to a lower portion of the rotor part in the axial direction; a second bearing part coupled to a lower portion of the stopper in the axial direction; a housing enclosing an outer side of the rotor part and formed to include the first and second bearing parts; and a position detecting part coupled to a lower portion of the second bearing part in an axial direction and formed at an outer side of the housing.

The position detecting part may include: an encoder body formed so as to correspond to the rotor part; and a sensing part sensing rotation of the rotor part through rotation of the encoder body.

The switched reluctance motor assembly may further include: a front part formed at the upper portion of the first bearing part in the axial direction and supporting the first bearing part; a diffuser part coupled to an upper portion of the front part in the axial direction; and an impeller part coupled to an upper portion of the diffuser part in the axial direction and coupled to the shaft.

The switched reluctance motor assembly may further include: a housing coupled to enclose outer peripheral surfaces of the first and second bearing parts; and a cover member coupled to an upper portion of the housing in the axial direction.

The switched reluctance motor assembly may further include a step part formed to be protruded along an outer peripheral surface of the housing to thereby allow the cover member to be seated thereon.

The stopper may be a balancing member.

The rotor part may include an annular rotor core and a plurality of rotor poles protruded outwardly from the rotor core.

The switched reluctance motor assembly may further include a stator part including: a stator yoke receiving the rotor part therein; and stator salient poles formed to be spaced apart from each other so as to correspond to the rotor poles and formed to be protruded inwardly of the stator yoke The switched reluctance motor assembly may further include at least one assembling hole formed at corresponding positions of each of the encoder body, the rotor part, and the housing in the axial direction in order to adjust a coupling position among the encoder body, the rotor part, and the housing.

### BRIEF DESCRIPTION OF THE DRAWINGS

FIG. 1 is a cross-sectional view of a switched reluctance motor assembly according to a preferred embodiment of the present invention;

FIG. 2 is a partial perspective view of the switched reluctance motor assembly according to the preferred embodiment of the present invention;

FIG. 3 is an exploded cross-sectional view of the switched reluctance motor assembly according to the preferred embodiment of the present invention;

FIG. 4 is a partial perspective view of the switched reluctance motor assembly according to the preferred embodiment of the present invention; and

FIG. 5 is a schematic cross-sectional view of a rotor part and a stator part according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

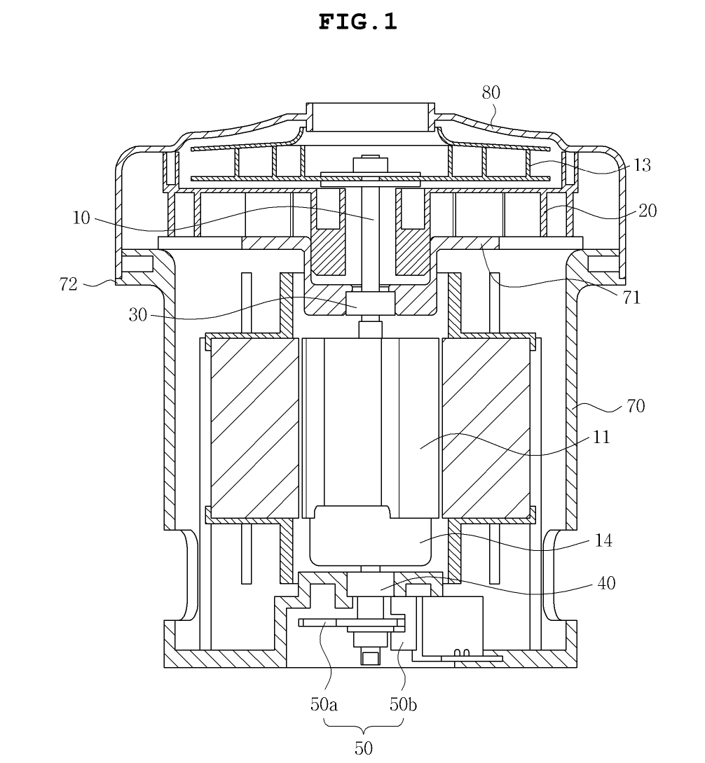

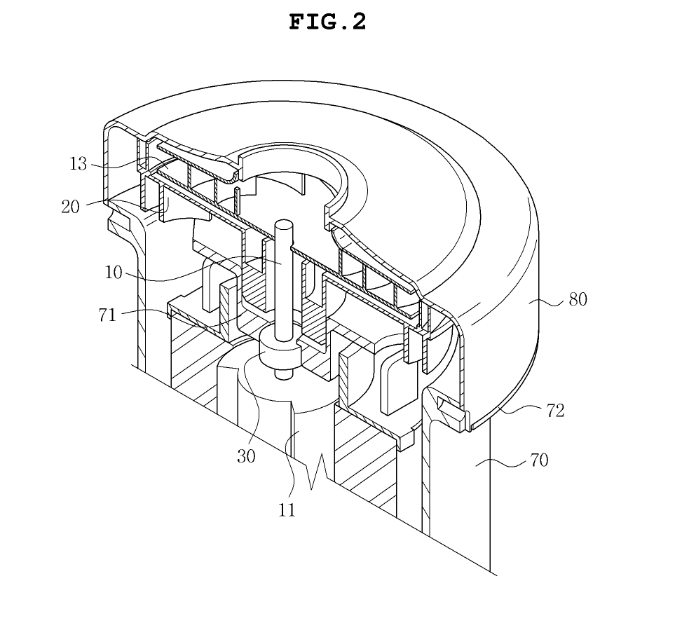

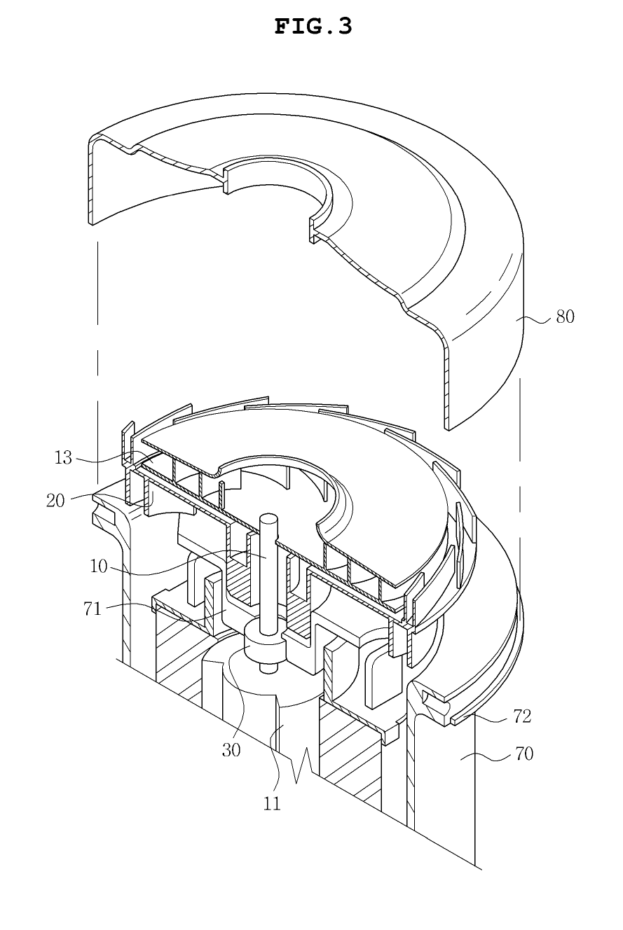

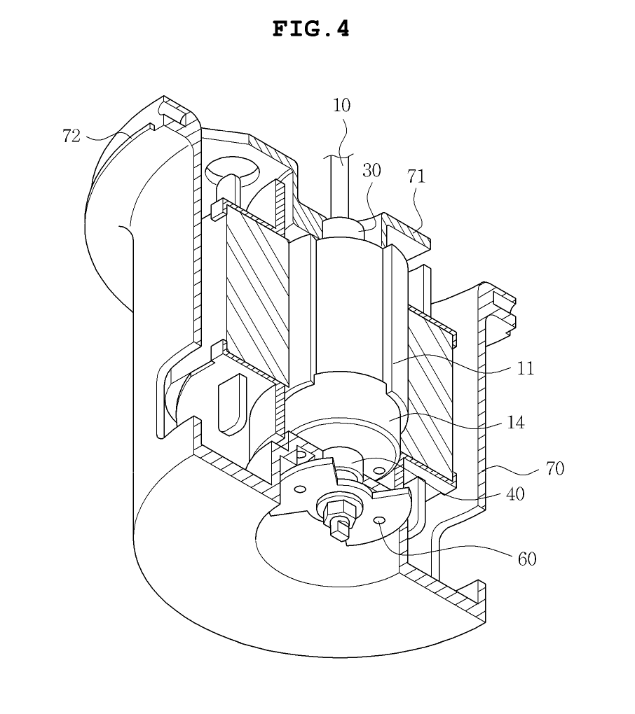

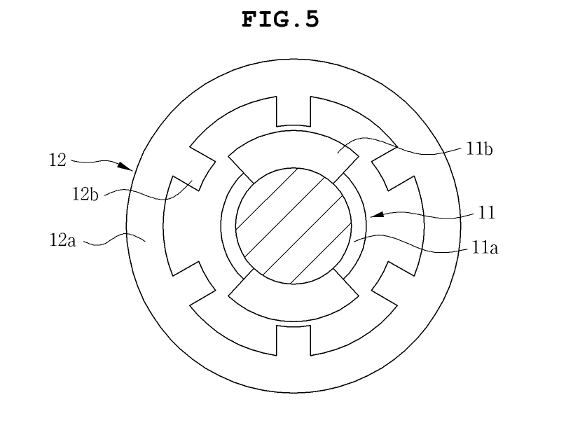

FIG. 1 is a cross-sectional view of a switched reluctance motor assembly according to a preferred embodiment of the present invention; FIG. 2 is a partial perspective view of the switched reluctance motor assembly according to the preferred embodiment of the present invention; FIG. 3 is an exploded cross-sectional view of the switched reluctance motor assembly according to the preferred embodiment of the present invention; FIG. 4 is a partial perspective view of the switched reluctance motor assembly according to the preferred embodiment of the present invention; and FIG. 5 is a schematic cross-sectional view of a rotor part and a stator part according to the preferred embodiment of the present invention.

The switched reluctance motor assembly according to the preferred embodiment of the present invention is configured to include a shaft 10 becoming the rotation center of the motor, a rotor part 11 rotatably coupled to the shaft 10, a first bearing part 30 coupled to an upper portion of the rotor part 11 in an axial direction, a stopper 14 coupled to a lower portion of the rotor part 11 in the axial direction, and a second bearing part 40 coupled to a lower portion of the stopper 14 in the axial direction.

The shaft 10 becomes the rotation center of the motor and is formed to be extended in the axial direction. Particularly, the axial direction in the present invention, which is based on a direction in which the shaft 10 is formed, refers to directions toward upper or lower portions based on the shaft 10 shown in FIG. 1. A rotor part 11 to be described below is coupled to the shaft 10 becoming the rotation center of the motor.

As shown in FIGS. 1 and 5, the rotor part 11 may be configured to include an annular rotor core 11a and a plurality of rotor poles 11b protruded outwardly from the rotor core 11a. The rotor core 11a has a hollow hole formed at a central portion thereof, and the shaft 10 is fixedly coupled to the hollow hole to thereby transfer rotation of the rotor part 11 to the outside. The plurality of rotor poles 11b may be formed to be protruded outwardly along an outer peripheral surface of the rotor core 11a and be formed to correspond to stator salient poles 12b to be described below.

As shown in FIG. 5, a stator part 12 is configured to include a stator yoke 12a and stator salient poles 12b. The stator yoke 12a may include a hollow hole formed so as to receive the rotor part 11 therein, and a plurality of stator salient poles 12 may be formed to be protruded from an inner side of the stator yoke 12a and correspond to the rotor poles 11b of the rotor part 11. Current is applied to the stator salient poles 12b of the stator yoke 12a to form a magnetic flux path through the stator salient poles 12b and the rotor poles 11b of the rotor part 11 facing the stator salient poles 12b, such that the rotor part 11 rotates.

The first bearing part 30 is a component rotating the rotor part 11 while supporting weight in the axial direction of the shaft 10 including the rotating rotor part 11 and a load applied to the shaft 10. The first bearing part 30 is coupled to the upper portion of the rotor part 11 in the axial direction and is positioned in a housing 70 of the motor to be described below. According to the preferred embodiment of the present invention, a structure in which the bearing parts formed at upper and lower portions of the shaft 10 in the axial direction has a narrow interval therebetween is implemented, thereby reducing vibration generated at the time of driving of the motor. Therefore, the first bearing part 30 is formed axially over the rotor part 11 coupled to the shaft 10 and is coupled so as to be positioned in the housing 70. A front part 71 to be described below supports the first bearing part 30 from an upper portion of the first bearing part 30 in the axial direction toward a lower portion thereof in the axial direction and is fixedly coupled to the first bearing part 30.

The stopper 14 is coupled to the lower portion of the rotor part 11 in the axial direction to thereby serve to support the rotor part 11. The stopper 14 is coupled to the shaft 10 while supporting the rotor part 11, thereby rotating together with the rotor part 11. The stopper 14 may support the rotor part 11 in the axial direction and may be made of a resin such as a plastic, or the like, to thereby be formed as a balancing member capable of adjusting rotation balancing at the time of rotation of the motor. As a balancing method, a method of cutting a portion of a balancing member in order to maintain balancing at the time of the rotation of the motor or a method of coupling a separate weight member to a balancing member may be used. In addition to the above-mentioned methods, various methods for rotation balancing of the motor may be selected and used by those skilled in the art. In addition, the stopper 14 may be formed by processing a plastic, or the like, or be formed integrally with the rotor part 11 by injection.

The second bearing part 40 may be coupled to the lower portion of the stopper 14 in the axial direction. The second bearing part 40 is coupled so as to be disposed in the housing 70 of the motor together with the first bearing part 30. The number of components disposed between the first and second bearing parts 30 and 30 is minimized, thereby making it possible to reduce a distance in the axial direction between the first and second bearing parts 30 and 40. The distance in the axial direction between the first and second bearing parts 30 and 40 is reduced, thereby making it possible to reduce mechanical vibration generated at the time of the driving of the motor. The vibration is reduced, thereby making it possible to reduce noise generated in the motor.

In addition, the switched reluctance motor assembly according to the embodiment of the present invention further includes the front part 71 formed at the upper portion of the first bearing part 30 in the axial direction and supporting the first bearing part 30, a diffuser part 20 coupled to an upper portion of the front part 71 in the axial direction, and an impeller part 13 coupled to an upper portion of the diffuser part 20 in the axial direction and coupled to the shaft 10.

The front part 71 may be formed of a separate member coupled to the housing 70 so as to be coupled to the upper portion of the first bearing part 30 in the axial direction to thereby support the first bearing part 31 as described above. The front part 71 may have a shape in which a central portion thereof is depressed as shown in FIGS. 1 and 2 and support the first bearing part 30. However, a shape of the front part 71 is not limited thereto. That is, various structures of the front part 71 capable of supporting the first bearing part 30 may be selected and used by those skilled in the art.

The diffuser part 20 is coupled to the upper portion of the front part 71 in the axial direction. The diffuser part 20 serves to change a direction of introduced air so that air sucked by an impeller part 13 to be described below is diffused toward both sides of the shaft 10 to which the rotor part 11 is coupled.

The impeller part 13 is coupled to the upper portion of the diffuser part 20 in the axial direction and is coupled to the shaft 10. The impeller part 13 is coupled to the shaft 10 to rotate together with the shaft 10 at the time of the rotation of the motor, thereby sucking external air. Particularly, a vacuum cleaner including the switched reluctance motor assembly is shown in FIG. 1. Here, the impeller rotates in order to introduce the air from the outside at the time of operation of the cleaner. The impeller part 13 may be manufactured so as to have a direction and a shape of a blade formed at an inner side in order to introduce the external air. Since a detailed structure of the impeller may be easily designed and applied by those skilled in the art, a detailed description thereof will be omitted.

In addition, the switched reluctance motor assembly according to the embodiment of the present invention further includes the housing 70 enclosing an outer side of the rotor part 11 and formed to include the first and second bearing parts 30 and 40 and a cover member 80 coupled to an upper portion of the housing in the axial direction.

The housing 70 is formed to be spaced apart from the rotor part 11, the stopper 14, and the first and second bearing parts 30 and 40 so as to enclose the rotor part 11, the stopper 14, and the first and second bearing parts 30 and 40. The housing 70 protects internal components thereof such as the rotor part 11, the stator part, and the like, and prevents other foreign materials from being introduced thereinto, thereby improving operation reliability of the motor. The housing may have a step part 72 formed on an outer peripheral surface of an upper portion thereof so that a cover member 80 to be described below is coupled thereto. The step part 72 is formed to be protruded from the outer peripheral surface of the housing 70, thereby making it possible to improve precision of a coupling height at the time of assembly of the cover member 80. Particularly, as shown in FIG. 1, since a height of the cover member 80 coupled to the upper portion of the impeller is closely associated with improvement of motor efficiency, reliability of the assembling height is a very important factor. Therefore, the precision of the assembling height of the cover member 80 increases through the step part 72 formed on the outer peripheral surface of the housing 70, thereby making it possible to improve the efficiency of the switched reluctance motor assembly.

The cover member 80 is coupled to the upper portion of the housing 70 in the axial direction as shown in FIGS. 2 and 3. As described above, the assembling height of the cover member 80 coupled to the impeller is an important factor. The cover member 80 adjusts a height at which it is coupled to the upper portion of the impeller, simultaneously with serving to cover the upper portion of the housing 70, thereby making it possible to improve the efficiency of the motor. To this end, the step part 72 is formed on the outer peripheral surface of the housing 70. Since other detailed description is overlapped with that of the preferred embodiment of the present invention, it will be omitted.

A switched reluctance motor assembly according to another preferred embodiment of the present invention is configured to include a shaft 10 becoming the rotation center of the motor, a rotor part 11 rotatably coupled to the shaft 10, a first bearing part 30 coupled to an upper portion of the rotor part 11 in an axial direction, a stopper 14 coupled to a lower portion of the rotor part 11 in the axial direction, a second bearing part 40 coupled to a lower portion of the stopper 14 in the axial direction, a housing 70 enclosing an outer side of the rotor part 11 and formed to include the first and second bearing parts 30 and 40, and a position detecting part 50 coupled to a lower portion of the second bearing part 40 in an axial direction and formed at an outer side of the housing.

Hereinafter, a detailed description of a configuration overlapped with that of the preferred embodiment of the present invention will be omitted. The switched reluctance motor assembly according to another preferred embodiment of the present invention may further include the position detecting part 50 coupled to the lower portion of the second bearing part 40 in the axial direction and formed at the outer side of the housing 70.

In addition, since the second bearing is formed at an inner side of the housing 70, assembling holes 60 may be further formed in order to align the coupling among the stopper 14, the housing 70, and an encoder body 50a. A detailed description thereof will be provided below.

The position detecting part 50 includes the encoder body 50a formed so as to correspond to the rotor part 11 and a sensing part 50b sensing rotation of the rotor part 11 through rotation of the encoder body 50a.

The encoder body 50a may be formed to have a shape corresponding to those of the rotor core 11a and the rotor pole 11b of the rotor part 11 so that a rotational position of the rotor part 11 may be detected. The encoder body 50a is formed to have one side inserted into the sensing part 50 so that the rotational position of the rotor part 11 may be detected by a sensing part 50b to be described below. Particularly, in the case in which a photo-sensor is used, the rotational position of the rotor part 11 may be detected by a difference between sensed values obtained by irradiating light from upper and lower portion.

The sensing part 50b uses the photo-sensor at upper and lower portions of one side of the encoder body 50a as shown in FIG. 1, thereby making it possible to detect the rotational position of the rotor part 11 through the encoder body 50a having a shape corresponding to that of the rotor part 11. A sensor used in the sensing part 50b is not particularly limited but may be a photo type sensor, a surface mounted device (SMD) type sensor, or the like.

The assembling holes 60 may be formed at corresponding positions of each of the encoder body 50a, the rotor part 11, and the housing 70 in the axial direction in order to adjust a coupling position among the encoder body 50a, the rotor part 11, and the housing 70 as shown in FIG. 4. Since the assembling hole 60 is formed according to the alignment assembled in the axial direction, a pin, or the like, is inserted into the assembling hole 60 in a subsequent process, thereby making it possible to easily specify an assembly position. Particularly, as described above, the encoder body 50a is formed to have a shape corresponding to that of the rotor part 11 in order to detect the rotational position of the rotor part 11 and rotates together with the rotor part at an accurate position, thereby making it possible to secure reliability in detecting position of the rotor part 11. Therefore, at least one assembling hole 60 may be formed at corresponding positions of each of the encoder body 50a, the rotor part 11, and the housing 70 in order to accurately perform coupling among the encoder body 50a, the rotor part 11, and the housing 70.

As set forth above, according to the preferred embodiments of the present invention, the distance in the axial direction between the bearing parts formed at both sides based on the shaft of the switched reluctance motor is reduced, thereby making it possible to reduce vibration and noise generated at the time of driving of the motor.

In addition, the distance in the axial direction between the bearing parts of the switched reluctance motor is reduced to reduce vibration at the time of the driving of the motor, thereby making it possible to improve operation performance and operation reliability of the motor.

Further, the assembling holes for determining relative assembling positions of the encoder body and the rotor part of the switched reluctance motor are formed in the encoder body, the balancing member, and the housing, thereby making it possible to facilitate assembly and improve assembly reliability.

Furthermore, the step part is formed at the coupling part of the housing in order to improve precision of the assembling height of the cover member coupled to the housing of the switched reluctance motor, such that assembly reliability of motor is improved, thereby making it possible to improve operation performance of the motor.

Although the preferred embodiments of the present invention have been disclosed for illustrative purposes, they are for specifically explaining the present invention and thus a switched reluctance motor assembly according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor assembly comprising:
a shaft becoming the rotation center of the motor;
a rotor part rotatably coupled to the shaft;
a first bearing part coupled to an upper portion of the rotor part in an axial direction;
a stopper coupled to a lower portion of the rotor part in the axial direction; and
a second bearing part coupled to a lower portion of the stopper in the axial direction.

2. The switched reluctance motor assembly as set forth in claim 1, further comprising:
a front part formed at the upper portion of the first bearing part in the axial direction and supporting the first bearing part;
a diffuser part coupled to an upper portion of the front part in the axial direction; and
an impeller part coupled to an upper portion of the diffuser part in the axial direction and coupled to the shaft.

3. The switched reluctance motor assembly as set forth in claim 1, further comprising:
a housing enclosing an outer side of the rotor part and formed to include the first and second bearing parts; and
a cover member coupled to an upper portion of the housing in the axial direction.

4. The switched reluctance motor assembly as set forth in claim 3, further comprising a step part formed to be protruded along an outer peripheral surface of the housing to thereby allow the cover member to be seated thereon.

5. The switched reluctance motor assembly as set forth in claim 1, wherein the stopper is a balancing member.

6. The switched reluctance motor assembly as set forth in claim 1, wherein the rotor part includes an annular rotor core and a plurality of rotor poles protruded outwardly from the rotor core.

7. The switched reluctance motor assembly as set forth in claim 6, further comprising a to stator part including:
a stator yoke receiving the rotor part therein; and
stator salient poles formed to be spaced apart from each other so as to correspond to the rotor poles and formed to be protruded inwardly of the stator yoke.

8. A switched reluctance motor assembly comprising:
a shaft becoming the rotation center of the motor;
a rotor part rotatably coupled to the shaft;
a first bearing part coupled to an upper portion of the rotor part in an axial direction;
a stopper coupled to a lower portion of the rotor part in the axial direction;
a second bearing part coupled to a lower portion of the stopper in the axial direction;
a housing enclosing an outer side of the rotor part and formed to include the first and second bearing parts; and
a position detecting part coupled to a lower portion of the second bearing part in an axial direction and formed at an outer side of the housing.

9. The switched reluctance motor assembly as set forth in claim 8, wherein the position detecting part includes:
an encoder body formed so as to correspond to the rotor part; and
a sensing part sensing rotation of the rotor part through rotation of the encoder body.

10. The switched reluctance motor assembly as set forth in claim 8, further comprising:
a front part formed at the upper portion of the first bearing part in the axial direction and supporting the first bearing part;
a diffuser part coupled to an upper portion of the front part in the axial direction; and
an impeller part coupled to an upper portion of the diffuser part in the axial direction and coupled to the shaft.

11. The switched reluctance motor assembly as set forth in claim 8, further comprising:
a housing coupled to enclose outer peripheral surfaces of the first and second bearing parts; and
a cover member coupled to an upper portion of the housing in the axial direction.

12. The switched reluctance motor assembly as set forth in claim 11, further comprising a step part formed to be protruded along an outer peripheral surface of the housing to thereby allow the cover member to be seated thereon.

13. The switched reluctance motor assembly as set forth in claim 8, wherein the stopper is a balancing member.

14. The switched reluctance motor assembly as set forth in claim 8, wherein the rotor part includes an annular rotor core and a plurality of rotor poles protruded outwardly from the rotor core.

15. The switched reluctance motor assembly as set forth in claim 14, further comprising a stator part including:
a stator yoke receiving the rotor part therein; and
stator salient poles formed to be spaced apart from each other so as to correspond to the rotor poles and formed to be protruded inwardly of the stator yoke.

16. The switched reluctance motor assembly as set forth in claim 9, further comprising at least one assembling hole formed at corresponding positions of each of the encoder body, the rotor part, and the housing in the axial direction in order to adjust a coupling position among the encoder body, the rotor part, and the housing.
